(19) United States
(12) Patent Application Publication
(10) Pub. No.: US 2006/0105733 A1
(43) Pub. Date: May 18, 2006

(54) System and method for developing ultra-sensitive microwave and millimeter wave phase discriminators

(76) Inventors: Donald R. Singh, Apple Valley, MN (US); Douglas R. Carlson, Woodbury, MN (US)

Correspondence Address: Matthew S. Luxton;Honeywell International, Inc., Law Dept. AB2, 101 Columbia Road, Morristown, NJ, 07962, US

(21) Appl. No.: 11/067,725

(22) Filed: Mar. 1, 2005

Related U.S. Application Data
(60) Provisional application No. 60/627,903, filed on Nov. 16, 2004.

(51) Int. Cl. H04B 1/10

(52) U.S. Cl. 455/304

(57) ABSTRACT

A method and system for improving sensitivity of microwave and millimeter phase discriminators is disclosed. An exemplary embodiment of a phase discriminator includes two mixers inserted between two 90 degree hybrids. One hybrid splits the reference or LO signal into two signals of equal magnitude with a phase difference of 90 degrees. Similarly, the other hybrid splits the received RF signal into equal signals shifted 90 degrees in phase. One mixer receives an input set (e.g., LO and RF signals) with a zero-degree phase shift, and the other mixer receives the input set shifted in phase by 90 degrees. Thus, the leakage signals at the output of each mixer have the same magnitude but are 180 degrees apart in phase. The IF ports of the mixers are tied together, allowing the leakage signals of the mixers to combine destructively, thereby increasing isolation and sensitivity.

This application claims the benefit of U.S. Provisional Application No. 60/627,903, filed Nov. 16, 2004, which is herein incorporated by reference in its entirety.

This invention was made with Government support under contract no. DL-8-531322 awarded by the Air Force. The Government has certain rights in the invention.

### BACKGROUND

1. Field of the Invention

The present invention relates generally to phase discriminators. More specifically, the present invention relates to developing ultra-sensitive microwave and millimeter wave phase discriminators.

2. Background of the Invention

Microwave and millimeter wave phase discriminators are used in numerous applications to detect and measure the relative phase of a received microwave or millimeter signal that has been frequency or phase modulated. These applications include radar and communications, proximity sensors and in recently emerging applications involving accelerometers.

Most systems which require phase information use mixers to measure or compare the phase information. In such systems phase detection typically is performed by applying two identical frequency, constant amplitude signals to a mixer resulting in a DC output which is proportional to the phase difference between the two applied signals. Although a single diode can be used as a mixer, typical mixers are configured as four-diode ring, double balanced mixers.

FIG. 1 shows a schematic of a conventional mixer 100. Mixer 100 includes a radio frequency (“RF”) port 105a, a local oscillator (“LO”) port 105b and an intermediate frequency (“IF”) port 105c. RF port 105a receives an RF signal 110 as input. Likewise, LO port 105b receives a reference signal or local oscillator signal 120 as input. Because RF signal 110 and LO signal 120 have the same frequency, the output is zero Hertz (“Hz”) or DC. In an ideal case when no RF signal is present, the amplitude of this output is zero volts. However, practical mixers, such as mixer 100, have a small amount of voltage (e.g., DC offset) present at the output or IF port 105c. This offset voltage is due to slight leakage (“Lᵢₛₒ”) 140 between LO port 105b and RF port 105a.

Microwave and millimeter wave phase discriminators are particularly susceptible to problems with leakage because of the high frequencies involved. As frequency increases, LO-RF isolation decreases, which results in leakage increases. LO-RF isolation is a measure of the isolation (or lack of cross-talk or leakage) between the LO and RF ports. Finite isolation causes a part of the LO signal to leak into the RF port.

As previously mentioned, the amount of Lᵢₛₒ depends upon the quality of isolation between LO port 105b and RF port 105a. Due to finite LO-RF isolation a part of LO signal 120 leaks into RF signal 110 as Lᵢₛₒ 140. Lᵢₛₒ 140 acts as a standard RF signal 110 and mixes with LO signal 120 to produce a DC offset. Because this DC offset provides a barrier the RF signal must overcome to be detectable, it is undesirable because it reduces sensitivity.

LO-RF isolation is an important parameter affecting offset voltage. As isolation is increased, this offset voltage decreases. For example, it can be shown that for a typical 35 GHz GaAs monolithic microwave integrated circuit (“MMIC”) double balanced mixer (“DBM”) offset voltage drops dramatically from 141 mV to 8 mV when isolation increases from 25 dB to 50 dB.

To overcome the leakage so that the signal may be detected, RF signal 110 must be increased. For example, the return signal strength in a sensitive radar application is approximately −80 dB. A typical mixer 110 with only 30 dB of isolation receives an LO signal 120 strength of approximately 10 dB. In such a mixer, the Lᵢₛₒ signal 140 strength at RF port 105a is approximately −20 dB. Because Lᵢₛₒ signal 140 strength of −20 dB is much greater than the return radar signal strength by approximately 60 dB, the return radar signal cannot be detected. One solution is to increase the power of the RF transmission. By increasing the transmission power, it is possible to detect radar signal 110 without reducing the viewing range of the target. Another solution is to decrease the range of the target. Both solutions are undesirable because either the overall power consumption of the system increases or the radar range is limited.

Moreover, using a low noise amplifier (“LNA”) to amplify RF signal 110 before it is input into mixer 100 may not increase the signal strength sufficiently to overcome the effect of LO leakage. Particularly, in the example given above, the radar signal must be amplified by at least 60 or 70 dB to overcome the leakage signal. Typical LNAs in the millimeter and microwave frequency range have gains on the order of only 20 dB. Although it is possible in theory to cascade LNAs together to achieve the required overall 60 to 70 dB gain, such an approach is generally not practical due to the problem of oscillations. Thus, for microwave and millimeter wave applications the use of a LNA does not provide an effective solution.

Accordingly, what is needed is a solution for increasing isolation, thereby reducing DC offset and increasing sensitivity in a phase discriminator using mixers.

### BRIEF SUMMARY OF THE INVENTION

The present invention relates to a phase discriminator having increased LO-RF isolation to improve sensitivity. The phase discriminator includes a first coupler for receiving an input reference signal and dividing the input reference signal into a first reference signal and a second reference signal. The second reference signal is of equal magnitude to the first reference signal but is shifted in phase by 90 degrees from the first reference signal.

The phase discriminator further includes a second coupler for receiving an input data signal and dividing the input data signal into a first data signal and a second data signal. The second data signal is of equal magnitude to the first data signal but is shifted in phase by 90 degrees from the first data signal.

Also, the phase discriminator includes a first mixer for combining the first reference signal and first data signal, and a second mixer for combining the second reference signal and second data signal. An output port of the first mixer is tied to an output port of the second mixer.

### BRIEF DESCRIPTION OF THE DRAWINGS

FIG. 1 is a schematic diagram of a conventional mixer.

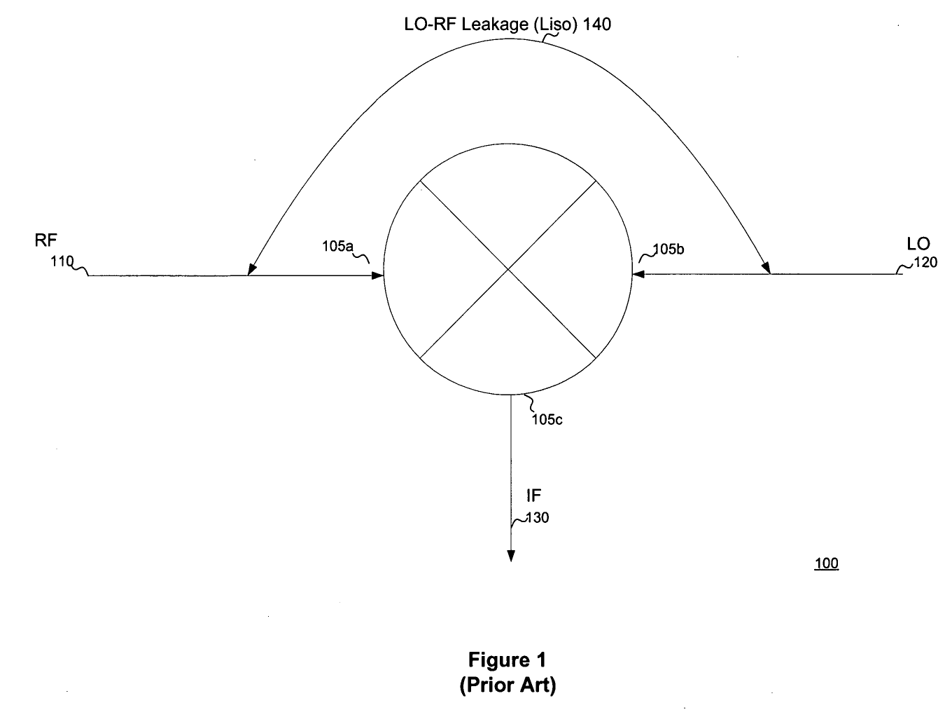

FIG. 2 is a schematic diagram of a phase discriminator according to a preferred embodiment of the present invention.

FIG. 3 illustrates exemplary steps of a phase discriminator according to a preferred embodiment of the present invention.

FIG. 4 shows a planar view of an experimental 35 GHz assembly according to a preferred embodiment of the present invention.

### DETAILED DESCRIPTION OF THE INVENTION

Embodiments of the present invention include systems and methods for reducing or eliminating the DC offset voltage resulting from leakage between an LO port and an RF port. Embodiments of the present invention use a unique passive circuit technique to reduce or eliminate RF leakage, thereby dramatically increasing overall mixer sensitivity. Moreover, this technique can be implemented in hybrid as well as monolithic microwave integrated circuits (“MMIC”).

Particularly, a method is disclosed in which two mixers are inserted between two 3 dB, 90-degree hybrids (couplers). The IF ports of both mixers are connected together to a common port. The LO port coupler divides the LO signal into two equal signals. In addition, the LO port coupler introduces a phase difference of 90 degrees in one of the signals. The LO signals drive the two mixers, and a small portion of each of the signals is channeled as LO-RF leakage to the RF inputs of two mixers. The leakage signals are coupled to the overall RF port using another 90-degree hybrid coupler. Because the RF port hybrid coupler introduces an additional 90-degree phase shift, the two signals at the RF port differ by 180 degrees (i.e. they are 180 degrees out-of-phase with one another), and thereby cancel each other. Because the leakage signals cancel each other, the offset voltage is substantially reduced if not eliminated entirely.

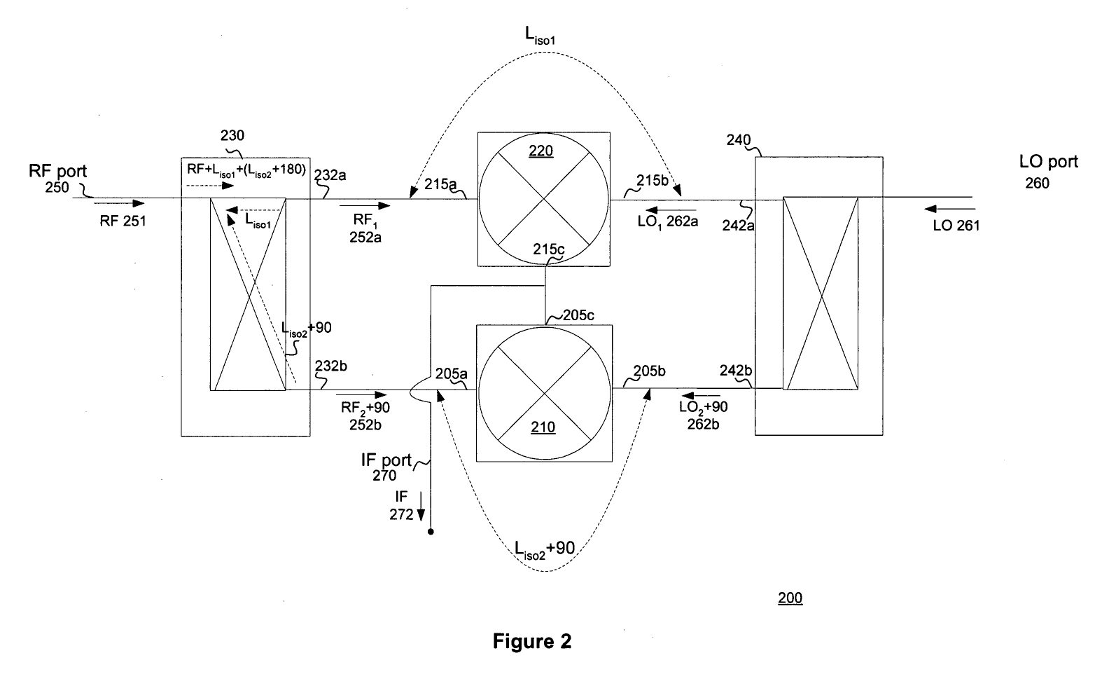

FIG. 2 is a schematic diagram of a phase discriminator 200 according to a preferred embodiment of the present invention. Phase discriminator 200 includes a mixer 210, a mixer 220, a 90-degree coupler 230, and a 90-degree coupler 240. Phase discriminator 200 further includes an RF port 250, an LO port 260 and an IF port 270. In a preferred embodiment of the present invention, mixers 210 and 220 are conventional double balanced mixer (“DBM”) GaAs monolithic microwave integrated circuits (“MMIC”). However, the present invention is not limited to any particular type of mixer. In principle, any mixer with a DC coupled port (even a single diode) can be used.

Mixer 210 includes an RF port 205a, an LO port 205b and an IF port 205c. Similarly, mixer 220 includes an RF port 215a, an LO port 215b and an IF port 215c. Mixer 210 receives an RF₂∠+90 signal 252b through a connection 232b at RF port 205a that is equal to and shifted 90 degrees in phase from an RF₁ signal 252a received by mixer 220 through a connection 232a at RF port 215a. Likewise, mixer 210 receives an LO₂∠+90 signal 262b at LO port 205b through a connection 242b that is equal to and shifted 90 degrees in phase from an LO₁ signal 262a received by mixer 220 through a connection 242a at LO port 215b. IF port 205c of mixer 210 is connected to IF port 215c of mixer 220 so that the output signals of each mixer combine to form an IF signal which exits IF port 270 of phase discriminator 200. The IF signal 272 from IF port 270 has a reduced or eliminated offset voltage due to destructive combination of the leakage signals associated with mixers 210 and 220, respectively.

Mixers 210 and 220 are inserted between 90-degree couplers or hybrids 230 and 240. In a preferred embodiment of the present invention, 90-degree couplers 230 and 240 are 3 dB-power divider GaAs MMIC chips. However, one of ordinary skill in the art will appreciate that the present invention is not limited to any particular coupler 230 or 240. Couplers 230 and 240 can be any coupler that equally divides a microwave or millimeter wave signal into two output signals and introduces a 90-degree phase offset to one of the signals.

Coupler 240 divides the input reference signal or local oscillator (“LO”) signal 261 received at LO port 260 equally into an LO, signal 262a and an LO₂ signal. Coupler 240 also shifts the phase of the LO₂ signal by 90 degrees from LO₂ signal 262a and is designated as LO₂/+90 signal 262b. LO₁ signal 262a drives mixer 220 and LO₂∠+90 signal 262b drives mixer 210. In addition, a small portion of LO₁ signal 262a channels via the LO-RF leakage phenomenon to RF port 215a as Lᵢₛₒ₁ and a small portion of LO₂/+90 signal 262b leaks into RF port 205a as Lᵢₛₒ₂/+90. Leakage signals Lᵢₛₒ₁ and Lᵢₛₒ₂∠+90 are coupled to RF port 250 through hybrid coupler 230 as Lᵢₛₒ₁ and Lᵢₛₒ₂∠+180. Since hybrid coupler 230 introduces an additional 90-degree phase shift, the two leakage signals at RF port 250, Lᵢₛₒ₁ and Lᵢₛₒ₂−+180, are now 180 degrees apart and thereby cancel each other. Thus, input signal RF 251 effectively enters the system without any added leakage signal. Because the leakage signals do not enter the system, the offset voltage at IF port 270 is substantially reduced or even completely eliminated. As a result, the sensitivity of the mixer is substantially increased.

For example, at coupler 240 a reference signal LO 261 is divided equally into LO₁ signal 262a and LO₂∠+90 signal 262b. LO₁ signal 262a exits LO coupler 240 with a zero degrees phase shift, LO₂∠+90 signal 262b exits LO coupler 240 with a 90-degree phase shift relative to LO₁ signal 262a. Some of LO₁ signal 262a leaks into RF port 215a of mixer 220 as Lᵢₛₒ₂∠+90, and some of LO₁ signal 262b leaks into RF port 205a of mixer 210 as Lᵢₛₒ₂∠+90. Lᵢₛₒ₂∠+90 is a version of Lᵢₛₒ₁ that has been shifted in phase by 90 degrees. Lᵢₛₒ₁ and Lᵢₛₒ₂∠+90 are much lower in magnitude than LO₁ signal 262a and LO₂∠+90 signal 262b, respectively.

Lᵢₛₒ₁ and Lᵢₛₒ₂∠+90 combine by reverse entry in 3 dB coupler 230 to emerge at the input port of coupler 230 as Lᵢₛₒ₁+Lᵢₛₒ₂∠+180. Particularly, 3 dB coupler 230 also shifts Lᵢₛₒ₂∠+90 by another 90 degrees so that Lᵢₛₒ₁ and Lᵢₒₛ₂+180 are 180 degrees apart at RF port 250 of phase discriminator 200. For example, RF coupler 230 shifts Lᵢₛₒ₁ by zero degrees and Lᵢₛₒ₂∠+90 by 90 degrees, so that Lᵢₛₒ₁ and Lᵢₛₒ₂ differ in phase by 180 degrees. Consequently, they substantially, if not completely, cancel one another when they reach RF port 250 of phase discriminator 200.

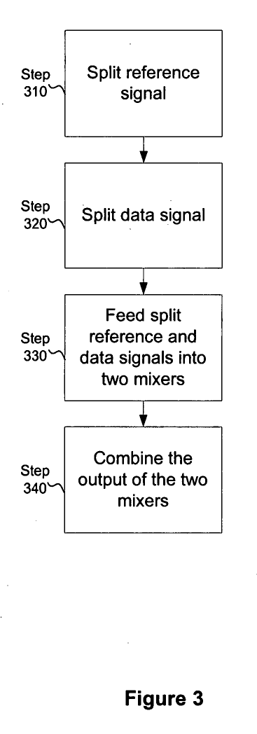

FIG. 3 illustrates exemplary steps of a phase discriminator according to a preferred embodiment of the present invention. In step 310 of the embodiment 300 shown in FIG. 3, an input reference signal is split into a first reference signal and a second reference signal of equal magnitude. The second reference signal is shifted in phase by 90 degrees from the first reference signal. Typically, an input reference signal is a reference signal provided by a local oscillator.

In step 320, an input data signal is split into a first data signal and a second data signal of equal magnitude. The second data signal is shifted in phase by 90 degrees from the first data signal. In a preferred embodiment of the invention, the input data signal is an RF signal received at an RF port of the phase discriminator.

In step 330, the split reference and data signals are fed into two mixers. Particularly, the first reference signal and first data signal are fed as inputs into a first mixer to produce an output at the IF port of the first mixer. Likewise, the second reference signal and second data signal are fed as inputs into a second mixer to produce an output at the IF port of the second mixer. Finally, in step 340 the IF outputs of the first and second mixers are combined. For example, the IF output of the first mixer is connected to the IF output of the second mixer. In this way, leakage signals of the first and second mixers substantially, if not completely, cancel each one another when they reach the RF port of the phase discriminator.

The inventors of the present invention created two experimental hybrid assemblies for verifying the technique of the present invention. The experimental hybrid assemblies operated at 18 GHz and 35 GHz, respectively.

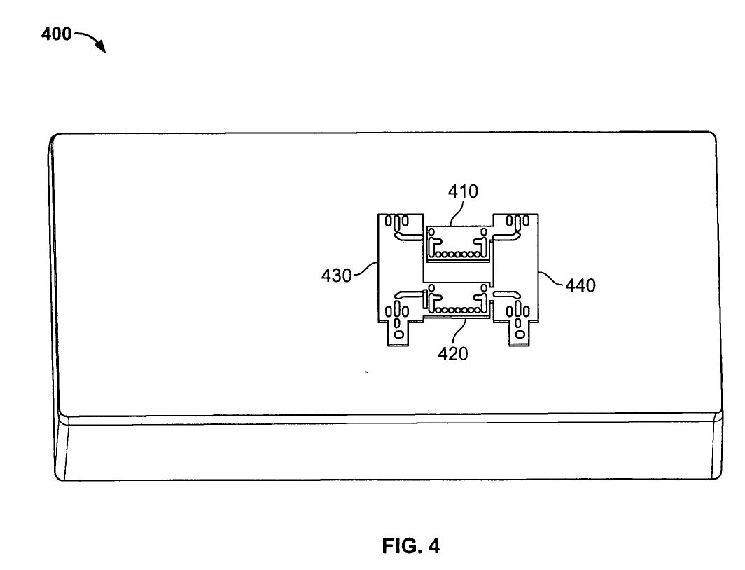

FIG. 4 shows a planar view of an experimental 35 GHz assembly according to a preferred embodiment of the present invention. The 35 GHz assembly 400 includes two Hittite HMC 329 mixer chips 410, 420 connected to two 3 dB Lange couplers 430, 440 cut from an Alpha AM038D1-00 mixer MMIC. Similarly, the 18 GHz assembly (not shown) included two Hittite HCM 203 mixer MMICs used together with 3 dB GaAs MMIC Lange couplers. A 90 mils bond wire and 0.5 pf capacitor were used to form an IF filter, which in turn was connected to a common 10 pf chip capacitor for further RF bypass. The complete circuits each were formed on a separate gold plated copper plate using silver epoxy, and measurements were taken using standard on-wafer RF probing techniques.

In both cases, the overall offset voltage of the individual mixer was reduced over 50-75% over a wide bandwidth using the technique disclosed herein. Because the experimental circuit was a hybrid circuit, it was difficult to maintain proper phases in both arms of the mixers and the offset voltage was not completely eliminated. In case of a MMIC design, where such phases can be more precisely controlled, offset voltage can be reduced even further and possibly eliminated.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A phase discriminator, comprising:
a first coupler for receiving an input reference signal and dividing the input reference signal into a first reference signal and a second reference signal of substantially equal magnitude, wherein the second reference signal is shifted in phase by 90 degrees relative to the first reference signal;
a second coupler for receiving an input data signal and dividing the input data signal into a first data signal and a second data signal of substantially equal magnitude, wherein the second data signal is shifted in phase by 90 degrees relative to the first data signal;
a first mixer for combining the first reference signal and first data signal; and
a second mixer for combining the second reference signal and second data signal,
wherein an output port of the first mixer is tied to an output port of the second mixer.

2. The phase discriminator of claim 1, wherein the first mixer and the second mixer are double balanced mixers.

3. The phase discriminator of claim 1, wherein the first mixer and the second mixers are formed on a monolithic microwave integrated circuit.

4. The phase discriminator of claim 1, wherein the first coupler and the second coupler are 3 dB-power dividers.

5. The phase discriminator of claim 1, wherein the input data signal is a microwave or millimeter wave.

6. The phase discriminator of claim 1, wherein the input data signal has a frequency greater than 35 GHz.

7. A method for determining phase, comprising:
splitting an input reference signal from a phase discriminator into a first reference signal and a second reference signal of substantially equal magnitude, wherein the second reference signal is shifted in phase by 90 degrees relative to the first reference signal;
splitting an input data signal into a first data signal and a second data signal of substantially equal magnitude, wherein the second data signal is shifted in phase by 90 degrees relative to the first data signal;
feeding the first reference signal and first data signal into a second mixer; and
combining the of the first and second mixer.

8. The method of claim 7, wherein the first mixer and the second mixer are double balanced mixers.

9. The method of claim 7, comprising forming the first mixer and the second mixers on a monolithic microwave integrated circuit.

10. The method of claim 7, wherein the first coupler and the second coupler are 3 dB-power dividers.

11. The method of claim 7, wherein the input data signal is a microwave or millimeter wave.

12. The method of claim 7, wherein the input data signal has a frequency greater than 35 GHz.

13. A phase discriminator, comprising:
a radio frequency (“RF”) coupler having a RF coupler input port, a RF coupler first output port and a RF coupler second output port, wherein the RF coupler first output port and the RF coupler second output port respectively emit a RF coupler first output signal and a RF coupler second output signal of substantially equal magnitude, the RF coupler second output signal being shifted in phase by 90 degrees relative to the RF first output signal;
a local oscillator (“LO”) coupler having a LO coupler input port, a LO coupler first output port and a LO coupler second output port, wherein the LO coupler first output port and the LO coupler second output port respectively emit a LO coupler first output signal and a LO coupler second output signal of substantially equal magnitude, the LO coupler second output signal being shifted in phase by 90 degrees relative to the LO first output signal;
a first mixer having a first mixer first input port, a first mixer second input port and a first mixer output port, the first mixer first input port and first mixer second input port being connected to the RF coupler first output port and the LO coupler first output port, respectively; and
a second mixer having a second mixer first input port, a second mixer second input port and a second mixer output port, the second mixer first input port and second mixer second input port being connected to the RF coupler second output port and the LO coupler second output port, respectively,
wherein the first mixer output port connects to the second mixer output port.

14. The phase discriminator of claim 1, wherein the first mixer and the second mixer are double balanced mixers.

15. The phase discriminator of claim 13, wherein the first mixer and the second mixer are formed on a monolithic microwave integrated circuit.

16. The phase discriminator of claim 13, wherein the RF coupler and the LO coupler are 3 dB-power dividers.
